(19) United States
(12) Patent Application Publication
(10) Pub. No.: US 2007/0259259 A1
(43) Pub. Date: Nov. 8, 2007

(54) Lithium Battery Which is Protected in Case of Inappropriate Use

(75) Inventors: Audrey Martinent, Grenoble (FR); Sebastien Martinet, Grenoble (GB); Helene Lignier, Seyssinet-Pariset (FR); Djamel Mourzagh, Fontaine (FR)

Correspondence Address: OLIFF & BERRIDGE, PLC, P.O. BOX 19928, ALEXANDRIA, VA, 22320, US

(73) Assignee: COMMISSARIAT A L'ENERGIE ANTOMIQUE, PARIS (FR)

(21) Appl. No.: 10/585,922

(22) PCT Filed: Feb. 4, 2005
(86) PCT No.: PCT/FR05/00252

§ 371 Date: Jul. 13, 2006

(30) Foreign Application Priority Data
Feb. 12, 2004 (FR) 04 01404

(51) Int. Cl. H01M 6/16

(52) U.S. Cl. 429/122; 429/326

(57) ABSTRACT

A lithium battery comprises at least a positive electrode containing a material whose lithium insertion and deinsertion potential is lower than or equal to 3.5 Volts in relation to the potential of the Li+/Li couple, a negative electrode and a non-aqueous electrolyte disposed between the positive and negative electrodes. The electrolyte comprises at least a lithium salt dissolved in an aprotic organic solvent wherein a polymerizable additive is added, chosen from carbazol and the derivatives thereof and being used to prevent the battery from operating as soon as the voltage at the terminal connections of the battery reaches a value resulting in polymerization of the additive.

### BACKGROUND OF THE INVENTION

The invention relates to a lithium battery comprising at least a positive electrode, a negative electrode and a non-aqueous electrolyte disposed between the positive and negative electrodes and comprising at least a lithium salt dissolved in an aprotic organic solvent wherein is added a polymerizable additive designed to prevent the battery from operating as soon as the voltage at the terminal connections of the battery reaches a value resulting in polymerization of the additive.

The invention also relates to the use of a polymerizable additive chosen from carbazol and the derivatives thereof and designed to prevent a lithium battery from operating in case of inappropriate use thereof, the battery comprising at least:
a positive electrode,
a negative electrode, and
a non-aqueous electrolyte disposed between the positive and negative electrodes and comprising at least a lithium salt dissolved in an aprotic organic solvent,
   the polymerizable additive being added to the solvent of the non-aqueous electrolyte.

### STATE OF THE ART

Lithium batteries, and more particularly batteries of the Lithium-Ion type, are tending to replace nickel-cadmium based (Ni—Cd) or nickel-hydride based (Ni-MH) rechargeable batteries as autonomous energy source, in particular in portable equipment items. Lithium batteries do in fact present better performances, and in particular a higher mass energy density, than those of Ni—Cd and Ni-MH batteries.

As lithium is a very reactive element, safety problems may however arise in lithium batteries, in particular in the case of inappropriate use, for example when used on overload. Using a battery on overload can in fact cause temperature and pressure increases inside the battery that are liable to result in an explosion or a risk of fire.

To prevent risks linked with incorrect conditions of use, and in particular in the event of prolonged use on overload, it has been proposed by certain people to add an external or internal electronic circuit and/or maybe a safety vent to the lithium battery, as described in the document EP-A-0918359. These means enable operation of the battery to be stopped when the latter is used on overload, but they are costly and they reduce the mass and volume energy densities of the batteries.

In the U.S. Pat. No. 5,506,068, it has been proposed to inhibit operation of a battery when the latter is used on overload by means of an organic solvent able to polymerize above 100° C. and/or above a maximum charge voltage of 4 Volts at the battery terminals. The battery thus comprises a metallic lithium electrode, a MnO₂ electrode and an electrolyte composed of LiAsF₆ dissolved in the solvent 1,3-dioxolane and in which a stabilizing agent containing a functional amino group is added.

Even if such a protection means works for batteries comprising a positive electrode made of MnO₂, it is not however suitable for other positive electrodes called low-voltage electrodes. A battery comprising a separating element formed by a microporous film of polyethylene impregnated with an electrolyte according to the U.S. Pat. No. 5,506,068 and a low-voltage positive electrode, other than MnO₂, has in fact been tested. It comprises a negative electrode made of Li₄Ti₅O₁₂, a positive electrode made of LiFePO₄ and an electrolyte formed by a lithium salt LiAsF₆ dissolved, at one mole per litre, in a 1,3-dioxolane solvent, stabilized by 100 ppm of tributylamine. The LiFePO₄ positive electrode has a lithium insertion and deinsertion potential equal to 3.5V in relation to the electrochemical potential of the Li⁺/Li couple noted V_{Li+/Li}.

FIG. 1 represents the evolution of the voltage at the terminals of the battery versus time (curve A1) and the evolution of the current flowing in the battery versus time (curve B1), thus illustrating the charging and discharging cycles of the tested battery, in a voltage range comprised between 1.5V and 2V. The maximum load voltage is chosen at 2 Volts, which means that the potential of the positive electrode does not exceed the value of 3.55V in relation to the potential of the Li⁺/Li couple. The polymerization potential of 1,3-dioxolane, about 4V, is thus never reached.

FIG. 1 illustrates the performances of the battery in normal operation. Charges and discharges are performed in galvanostatic C/10 regime. At the end of charging, when the voltage of the battery reaches the value of 2 Volts, the battery is kept at this voltage if one of the following two conditions is not fulfilled: a duration of the charging step greater than or equal to 5 hours or a current lower than or equal to 10 μA. The next step is then galvanostatic discharge in C/10 regime. What is meant is by C/10 regime is that, theoretically, charging and discharging of the battery have to be performed respectively in 10 hours and a full cycle comprising charging and discharging must take about 20 hours. However, as observed in FIG. 1, the first charging and discharging cycle of the battery takes place in 14 hours instead of the expected 20 hours and the following cycles are shorter and shorter. Shortening of the cycles proves a progressive deterioration of the battery consecutive to impairment of the electrolyte, the 1,3-dioxolane probably having deteriorated prematurely.

To discharge a battery operating on overload, it has been proposed to create an internal short-circuit in the battery. Thus, in the U.S. Pat. No. 6,074,776, a monomer additive was added to the aprotic organic solvent of the non-aqueous electrolyte of a battery whose positive electrode is called a high-voltage electrode. The monomer additive is able to form an electronically conducting polymer, when the voltage at the terminals of the battery reaches a predetermined value above which the monomer can polymerize. The polymer thus formed then creates a conducting bridge between the two electrodes and therefore an internal court-circuit limiting the overload and then leading to automatic discharging of the battery. The monomer additive can be an aromatic additive, possibly heterocyclic. Thus, pyrrole, N-methylpyrrole and thiophene are for example used for batteries having maximum charge voltages lower than 4 Volts, furan, indole or 3-chlorothiophene are used for higher charge voltages and biphenyl is used for batteries operating at a voltage of about 4 Volts.

The polymerization potential of these compounds, comprised between 4.4V and 5.4 V in relation to V_{Li+/Li}, is thus suitable for batteries whose positive electrode is an electrode called a high-voltage electrode, and more particularly for batteries containing positive electrodes of LiNiO₂, LiCoO₂ or LiMn₂O₄ type, which insert and deinsert lithium at a potential of about 3.8V to 4V in relation to V_{Li+/Li}. However, they are not suitable for batteries whose positive electrode is an electrode called a low-voltage electrode, and in particular for batteries comprising a positive electrode with a lower lithium insertion and deinsertion potential. The voltage above which the battery deteriorates, with a possibility of explosion, is in fact liable to be reached before the additive polymerizes.

The U.S. Pat. No. 6,074,777 proposes adding an additive chosen from a phenyl-R-phenyl where R is aliphatic hydrocarbide, a biphenyl substituted by a fluorine and 3-thiophenactonitrile to the electrolyte solvent. The object of the additive is to generate a gas in a lithium battery whose positive electrode is an electrode called a high-voltage electrode, i.e. a battery having a maximum charge voltage of more than 4 Volts, so as to activate an electrical disconnection device. It also describes the possibility of using a polymerized additive to create an increase of the internal resistance of the battery so as to reduce the charging current during the overload. These compounds are, however, not suitable for low-voltage batteries.

In the U.S. Pat. No. 4,857,423, organometallic compounds, known under the name of metallocenes, are used to protect batteries against a possible overload. Thus, the compound oxidizes reversibly at a slightly higher potential than that of the charge and discharge plateau of the positive electrode and, once oxidized, the compound can be reduced under secondary reaction at the surface of the negative electrode. Unlike previous additives, the changes of the organometallic compound backwards and forwards between oxidized and reduced states enable the battery to be protected against a possible overload while leaving it operational. This type of compounds is however only usable for batteries having a positive electrode with a lithium insertion and deinsertion potential lower than 3 Volts in relation to V_{Li+/Li}. This considerably reduces the scope of application of these additives for few positive electrodes enable such a potential to be obtained.

### OBJECT OF THE INVENTION

It is an object of the invention to obtain a lithium battery whose positive electrode is called a low-voltage electrode and that is protected in case of inappropriate use, and more particularly in case of use on overload, while keeping good performances in normal operating conditions.

According to the invention, this object is achieved by the fact that the positive electrode containing a material having a lithium insertion and deinsertion potential lower than or equal to 3.5 Volts in relation to the electrochemical potential of the Li⁺/Li couple, the polymerizable additive is chosen from carbazol and the derivatives thereof.

According to a development of the invention, the electrolyte comprises between 2% and 10% by mass of polymerizable additive in relation to the total mass of the electrolyte.

According to a preferred embodiment, the positive electrode comprises a compound chosen from LiFePO₄, V₂O₅, LiV₃O₈, MnO₂, V₆O₁₃ and TiS₂.

According to another feature of the invention, the negative electrode comprises at least one lithium insertion compound.

According to a particular embodiment, the lithium insertion compound is chosen from a carbon composite material or a titanium and lithium oxide.

It is a further object of the invention to achieve efficient and appropriate use of a polymerizable additive chosen from carbazol and the derivatives thereof to prevent a lithium battery from operating in case of inappropriate use.

According to the invention, this object is achieved by the fact that, the positive electrode containing a material having a lithium insertion and deinsertion potential lower than or equal to 3.5 Volts in relation to the electrochemical potential of the Li⁺/Li couple, the polymerizable additive prevents the battery from operating as soon the voltage at the terminal connections of the battery reaches a value resulting in polymerization of the additive.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents a galvanostatic cycle in C/10 regime performed on the [1.5V-2V] range of a lithium battery whose positive electrode is an electrode called a low-voltage electrode, and comprising a non-aqueous electrolyte according to the prior art.

FIG. 2 represents a galvanostatic cycle in C/10 regime performed on the [1.5V-3.5V] range of a lithium battery according to the invention whose positive electrode is an electrode called a low-voltage electrode, said battery having previously undergone charging and discharging cycles in normal operation.

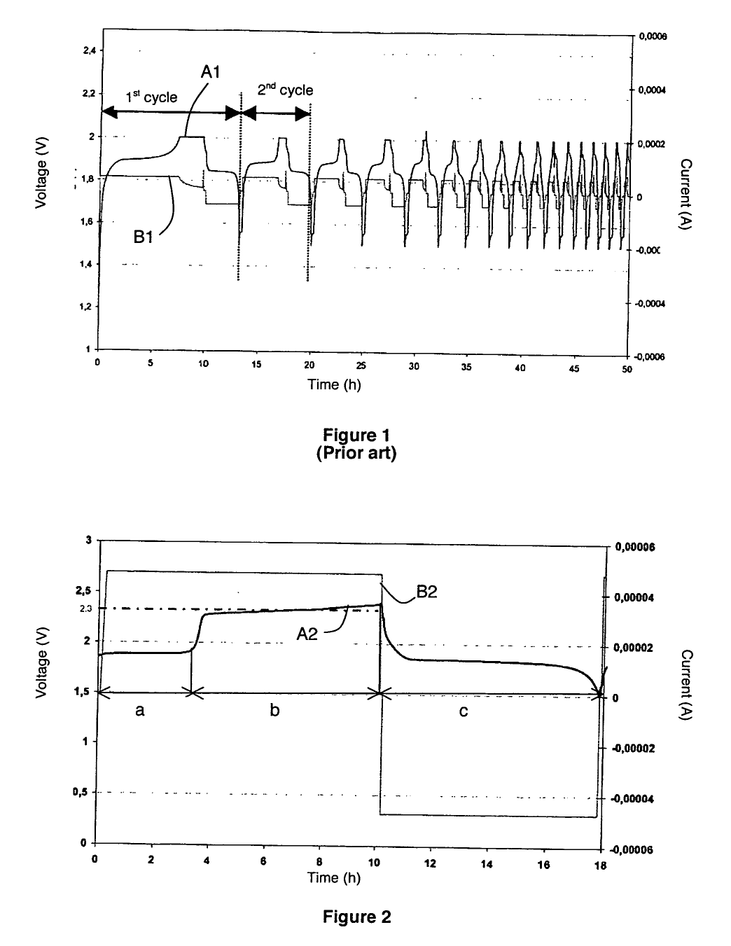

### DESCRIPTION OF PARTICULAR EMBODIMENTS

A lithium battery, preferably being of the Lithium-Ion type, comprises at least a positive electrode, a negative electrode and a non-aqueous electrolyte disposed between the positive and negative electrodes. What is meant by battery of the Lithium-Ion type is lithium batteries for which the negative electrode contains at least a lithium intercalation or insertion material, unlike batteries of the Lithium-Metal type for which the negative electrode is formed by a Li⁺ cation source, for example metallic lithium.

The positive electrode contains a material having a lithium insertion and deinsertion potential lower than or equal to 3.5 Volts in relation to the electrochemical potential of the Li⁺/Li couple (V_{Li+/Li}), and preferably higher than 3 Volts. For example, the positive electrode can contain a compound chosen from LiFePO₄, V₂O₅, LiV₃O₈, MnO₂, V₆O₁₃ and TiS₂.

The negative electrode preferably contains at least one lithium insertion compound chosen for example from a carbon composite material or a titanium and lithium oxide such as Li₄Ti₅O₁₂.

The non-aqueous electrolyte contains at least a lithium salt dissolved in an aprotic organic solvent. The lithium salt is preferably chosen from LiPF₆, LiBF₄, LiClO₄, LiAsF₆, LiPF₄, LiRFSO₃, LiCH₃SO₃, LiN(R_{F}SO₂)₂, LiN(R_{F}SO₂)₃, R_{F} being chosen from a fluorine atom and a perfluoroalkyl group comprising between 1 and 8 carbon atoms. The aprotic organic solvent is advantageously formed by a mixture chosen from a mixture of ethylene carbonate and dimethyl carbonate and a mixture of ethylene carbonate, dimethyl carbonate and diethyl carbonate. According to a particular embodiment, a separating element disposed between the positive and negative electrodes is impregnated by the non-aqueous electrolyte so as to support the electrolyte. Such a separating element is for example formed by a microporous polyethylene film.

To protect the lithium battery when it is used is inappropriate conditions and more particularly on overload, a polymerizable additive chosen from carbazol and the derivatives thereof is added to the aprotic organic solvent of the non-aqueous electrolyte. The empirical formula of carbazol, also called 9-azafluorene, dibenzopyrrole or diphenylenimine, is C₁₂H₉N, and what is meant by derivative of carbazol is a carbazol substituted by any type of known groups. The derivatives of carbazol are for example chosen from N-alkylcarbazols, alkyldibenzopyrroles, and 3,6-dichloro-9H-carbazol. Thus, the electrolyte preferably comprises between 2% and 10% by mass of polymerizable additive in relation to the total mass of the electrolyte.

The polymerizable additive is for example added to the non-aqueous electrolyte in an inert atmosphere at ambient temperature and preferably under argon with water and oxygen contents lower than 1 ppm. The electrolyte is then left to rest for at least 24 hours before being used in the battery.

The presence of such a polymerizable additive enables operation of the battery to be prevented as soon as the voltage at the terminals of the battery, i.e. the difference between the potential of the positive electrode and the potential of the negative electrode, reaches a value, noted U_{polymerization}, resulting in polymerization of the additive. Polymerization of the additive in fact induces a large increase of the internal resistance of the battery, which results in a progressive decrease of the current flow that may go as far as preventing operation of the battery. This value U_{polymerization} at the battery terminals corresponds to the potential difference between the polymerization potential of the additive, noted VP, and the potential of the negative electrode. What is meant by potential of an electrode or polymerization potential is the measured potential in relation to V_{Li+/Li}, i.e. the electrochemical potential of the Li⁺/Li couple.

Moreover, for a polymerizable additive to prevent the battery from operating at the most suitable moment, the value of U_{polymerization} has to be comprised between the maximum charge voltage of the battery, noted Uₘₐₓ, and the voltage above which there is a risk of the battery being damaged and in particular a risk of fire and/or explosion, noted Uᵣᵢₛₖ and which is higher than U_{polymerization}

For the battery to be efficiently protected against inappropriate use, the voltage U_{polymerization} must at most be about 500 mV higher than the value of Uₘₐₓ. The maximum charge voltage Uₘₐₓ at the battery terminals is chosen according to the materials constituting the battery so as to guarantee the lowest possible capacitance loss, typically a loss of 20% maximum over 500 charging and discharging cycles for portable applications.

The polymerization potential Vₚ of carbazol or of one of the derivatives thereof being about 3.8 Volts in relation to V_{Li+/Li}, these polymerizable additives are therefore particularly suitable for batteries whose positive electrode is an electrode called a low-voltage electrode, i.e. those that are composed of a positive electrode having a lithium insertion and deinsertion potential lower than or equal to 3.5 Volts in relation to V_{Li+/Li}.

This makes carbazol and the derivatives thereof better polymerizable additives for batteries whose positive electrode is an electrode called a low-voltage electrode than polymerizable additives of the prior art, and in particular better than the additives cited in the document U.S. Pat. No. 6,074,776. Polymerizable additives according to the prior art do in fact have a polymerisation potential comprised between 4.4V and 5.4V in relation to V_{Li+/Li}. They are therefore particularly suitable for batteries comprising a positive electrode with a lithium insertion and deinsertion potential comprised between 3.8 Volts and 4 Volts in relation to V_{Li+/Li}, for example a positive electrode made of LiCoO₂, LiNiO₂ or LiMn₂O₄. However, such polymerizable additives can not be used with a positive electrode with a lithium insertion and deinsertion potential that is lower than or equal to 3.5 Volts, polymerization of such additives being liable to take place at a too high voltage in relation to the maximum charge voltage.

Carbazol and the derivatives thereof are therefore particularly suitable for batteries having a positive electrode containing the compound LiFePO₄, the insertion and deinsertion potential of LiFePO₄ being about 3.5 Volts in relation to V_{Li+/Li}.

According to a particular embodiment, a lithium battery, and more particularly a Lithium-Ion battery of button cell format, comprises a negative electrode made of Li₄Ti₅O₁₂ and a positive electrode made of LiFePO₄. A separating element formed by a microporous polyethylene film is placed between the two electrodes and is impregnated with electrolyte. The electrolyte contains one mole of lithium salt LiPF₆ per litre of organic solvent formed by a 1:1 mixture of ethylene carbonate and dimethyl carbonate. The solvent also contains 2.5% by mass of carbazol in relation to the total mass of the electrolyte.

Such a lithium battery was tested under normal conditions of use and then under overload conditions. Thus, FIG. 2 represents the evolution of the voltage at the battery terminals versus time (Curve A2) and the evolution of the current flowing in the battery versus time (Curve B2), at the end of charging in C/10 regime performed over the range comprised between 1.5V and 3.5V, under the condition of stopping after 10 hours. In FIG. 2, part a corresponds to a period of normal conditions of use, part b corresponds to an overload period resulting in polymerization of the carbazol, whereas part c corresponds to a discharge period, the point where operation of the battery was completely inhibited not have been reached in the test illustrated in FIG. 2.

During the period of time corresponding to the region a, the battery displays identical performances to those expected for an equivalent battery not containing carbazol. The nominal voltage at the battery terminals is indeed 1.9 Volts, the plateau potentials of the positive and negative electrodes being respectively 3.45V and 1.55V in relation to V_{Li+/Li}.

Moreover, on overload, in the period of time corresponding to part b in FIG. 2, the voltage at the battery terminals does not exceed the value of 2.3 Volts which corresponds to the value U_{polymerization}, i.e. the voltage above which carbazol polymerizes. In this case, the value of the maximum charge voltage of the battery had been deliberately fixed at a very high value, at 3.5 Volts. However, as represented in FIG. 2, such a maximum voltage value is never reached, as the presence of the carbazol prevents the battery from operating at a voltage value of 2.3 Volts, i.e. only 400 mV above the nominal voltage of the battery.

In the prior art, the use of a carbazol type additive was mentioned among other additives so as to obtain a safer battery, notably eliminating risks associated with the problem of overload. For example, the Patent US2003/099886 describes a non-aqueous electrolyte containing an organic solvent wherein a lithium salt and an additive compound with the following general formula are dissolved:

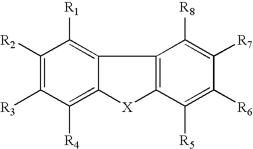

When all the groups R₁ to R₈ are hydrogen and when the group X is the group

—NH, the additive compound in fact corresponds to carbazol.

However, although carbazol was cited in the prior art among the additive compounds enabling the safety of a lithium battery to be improved, the applicants found that carbazol is only usable with a low-voltage positive electrode, i.e. a positive electrode containing a material having a lithium insertion and deinsertion potential lower than or equal to 3.5 Volts and more particularly with LiFePO₄. Carbazol and the derivatives thereof are in fact not usable with the lithium-ion batteries usually marketed, and more particularly with lithium-ion batteries comprising a positive electrode such as those that are described in the Patent US2003/099886, as carbazol and the derivatives thereof polymerize before the end of charging of the battery.

1-9. (canceled)

10. Lithium battery comprising at least:
a positive electrode,
a negative electrode
and a non-aqueous electrolyte disposed between the positive and negative electrodes and comprising at least a lithium salt dissolved in an aprotic organic solvent wherein is added a polymerizable additive designed to prevent the battery from operating as soon as the voltage at the terminal connections of the battery reaches a value resulting in polymerization of the additive,
wherein the positive electrode contains a material having a lithium insertion and deinsertion potential lower than or equal to 3.5 Volts in relation to the electrochemical potential of the Li+/Li couple and the polymerizable additive is selected from the group consisting of carbazol and the derivatives thereof.

11. Battery according to claim 10, wherein the electrolyte comprises between 2% and 10% by mass of polymerizable additive in relation to the total mass of the electrolyte.

12. Battery according to claim 10, wherein the positive electrode comprises a compound selected from the group consisting of LiFePO4, V2O5, LiV3O8, MnO2, V6O13 and TiS2.

13. Battery according to claim 10, wherein the negative electrode comprises at least one lithium insertion compound.

14. Battery according to claim 13, wherein the lithium insertion compound is selected from the group consisting of a carbon composite material or a titanium and lithium oxide.

15. Battery according to claim 10, wherein the aprotic organic solvent is formed by a mixture of solvents selected from the group consisting of ethylene carbonate, dimethyl carbonate and diethyl carbonate.

16. Battery according to claim 10, wherein the lithium salt is selected from the group consisting of LiPF6, LiBF4, LiClO4, LiAsF6, LiPF4, LiRFSO3, LiCH3SO3, LiN(RFSO2)2, LiN(RFSO2)3, RF being selected from the group consisting of a fluorine atom and a perfluoroalkyl group comprising between 1 and 8 carbon atoms.

17. Battery according to claim 10, comprising a separating element impregnated with a non-aqueous electrolyte and disposed between the positive and negative electrodes.

18. A method of preventing a lithium battery from operating in case of inappropriate use thereof, comprising providing said battery with a polymerizable additive selected from the group consisting of carbazol and the derivatives thereof and designed to prevent a lithium battery from operating in case of inappropriate use thereof, the battery comprising at least:
a positive electrode,
a negative electrode, and
a non-aqueous electrolyte disposed between the positive and negative electrodes and comprising at least a lithium salt dissolved in an aprotic organic solvent,
the polymerizable additive being added to the solvent of the non-aqueous electrolyte,
wherein the positive electrode containing a material having a lithium insertion and deinsertion potential lower than or equal to 3.5 Volts in relation to the electrochemical potential of the Li+/Li couple, the polymerizable additive prevents the battery from operating as soon the voltage at the terminal connections of the battery reaches a value resulting in polymerization of the additive.
